(19) United States
(12) Patent Application Publication
(10) Pub. No.: US 2009/0322147 A1
(43) Pub. Date: Dec. 31, 2009

(54) AIRCRAFT WITH ISOLATED GROUND

(76) Inventor: Daniel E. Cooney, Springville, UT (US)

Correspondence Address: NYDEGGER & ASSOCIATES, 348 OLIVE STREET, SAN DIEGO, CA, 92103, US

(21) Appl. No.: 12/113,761

(22) Filed: May 1, 2008

(51) Int. Cl. B60L 1/00; H01Q 1/28

(52) U.S. Cl. 307/9.1; 343/705

(57) ABSTRACT

An aircraft having an airframe made of a composite material is provided with an isolated ground in order to reduce the threat of electrical fires. The aircraft includes a voltage source and at least one electronic device mounted on the airframe. Further, a power wire isolated from the airframe interconnects the voltage source and the electronic device. Also, a ground wire isolated from the airframe interconnects the voltage source and the electronic device. As a result, the onboard electric circuits are isolated from the airframe. In order to reduce electromagnetic interference in the circuit, the aircraft may be provided with a powerside capacitor, to interconnect the power wire and the airframe, and a groundside capacitor, to interconnect the ground wire and the airframe.

### FIELD OF THE INVENTION

The present invention pertains generally to aircraft electrical systems. More particularly, the present invention pertains to electrical systems for aircraft having an airframe made of a carbon fiber composite material. The present invention is particularly, but not exclusively, useful as an aircraft electrical system with an isolated ground that prevents electrical current flow from the electrical system through the carbon fiber airframe.

### BACKGROUND OF THE INVENTION

In aircraft having conventional metallic conductive fuselage skins, the fuselage skins are used to ground the electrical components of the aircraft. Typically, a voltage source is connected to the electrical components through power wires, and the electrical components are grounded to the fuselage skin. Therefore, when shorts occur in power wires of conventional metal surface aircraft, the electricity simply flows back to the voltage source through the electrically conductive fuselage skin. As a result, all power will be passed immediately to the fuselage skin and a circuit breaker positioned on the power wire will be immediately tripped.

Unlike aircraft with metal fuselages, an aircraft made of a composite material will not have the same result. Instead, electricity from the shorted wire may pass from the wire to the airframe without tripping the circuit breaker. This may happen because the carbon fibers of the composite material will resist the flow of electricity and produce a current that is below the threshold required to trip the circuit breaker. At the same time, however, the resistance of the carbon fibers can cause an unwanted heating of the composite material. In this context, the carbon fibers may be compared to the filament of a light bulb. Further, the resistance heating may cause a rise in temperature sufficient to ignite the resin in the composite material and thereby cause extremely dangerous conditions during flight.

In addition to internal electrical considerations, composite material aircraft also must include safeguards for lightning strikes. While lightning striking a conventional aircraft often travels quickly through the fuselage skin, it will behave differently for a composite material aircraft. Specifically, the electricity will be resisted while passing through the less conductive composite material airframe. For composite material aircraft, this leads to a higher voltage differential and an increased risk of the current jumping, potentially through a critical electrical component, fuel cell, or persons onboard the aircraft. While it may be impossible to prevent all structural damage to composite material aircraft from lightning strikes, it is important to avoid the risk of lightning electricity jumping through the aircraft on its own path. If the electricity is not directed somewhere, it will find its own way through the aircraft. Therefore, there are important considerations regarding lightning for composite material aircraft that are not faced by conventional aircraft.

In light of the above, it is an object of the present invention to provide a system and method for providing an isolated ground for composite material aircraft. Another object of the present invention is to provide a system and method for isolating and grounding an antenna mounted on a composite material aircraft. Yet another object of the present invention is to provide an isolated ground electrical system for an aircraft that reduces electromagnetic interference and static electricity build up. Still another object of the present invention is to provide a system and method for isolating a ground in an aircraft that is easy to implement, is simple to use, and is comparatively cost effective.

### SUMMARY OF THE INVENTION

In accordance with the present invention, a system and method for isolating an electrical ground from the composite material airframe of an aircraft substantially reduces the threat of onboard fires caused by electrical shorts. Importantly, the system provides a mechanic, or an active resistance monitoring device, with the ability to detect circuits that are shorted to the airframe. In the system, a voltage source having a positive bus bar and a negative bus bar is mounted to the airframe. Further, an electronic device having a positive terminal and a negative terminal is mounted to the airframe. Accordingly, a power wire isolated from the airframe connects the positive terminal of the electronic device to the positive bus bar of the voltage source. Also, a circuit breaker is interconnected to the power wire. Further, a ground wire isolated from the airframe connects the negative terminal of the electronic device to the negative bus bar of the voltage source. As a result, a complete circuit that is isolated from the airframe is created.

Typically, the generators used by aircraft create electromagnetic interference. In order to eliminate electromagnetic interference on the circuit of the present invention, both the power wire and the ground wire may be connected to capacitors. Further, in order to reduce static electricity between the isolated circuit and the airframe, a pair of resistors may be interconnected between the wires and the airframe.

For purposes of the present invention, the aircraft includes an antenna that defines an antenna axis. In order to connect the antenna to the aircraft, while electrically isolating the antenna from the airframe, the airframe forms an aperture extending between its external and internal surfaces. Further, an external insulating gasket is positioned outside of the external surface to surround the aperture, and an internal insulating gasket is positioned inside of the internal surface to surround the aperture. Also, an antenna backing plate is positioned against the internal insulating gasket to fix the internal insulating gasket between the backing plate and the airframe. Mounted between the internal gasket and the airframe is a ground plane perpendicular to the antenna axis. Structurally, the ground plane is formed from a metallic wire mesh that surrounds the base of the antenna and is insulated from the airframe. The metallic mesh is contained in the outer layer of the composite airframe in the vicinity of the antenna. In order to ground the antenna, the ground plane mesh is electrically connected to the antenna.

For protection from lightning, the aircraft includes a second metallic mesh that is contained in the outer laminate of the composite airframe. Importantly, this lighting protective mesh is not applied in the vicinity of the antenna. Specifically, the ground plane mesh does not make electrical contact with the lightning protective mesh. Rather, the two distinct meshes are separated at the perimeter of the ground plane mesh by an insulating gap.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of an aircraft with a composite material airface and an isolated ground in accordance with the present invention;

FIG. 2 is a schematic view of the electrical system of the aircraft in FIG. 1; and

FIG. 3 is a cross sectional view showing the interconnection between the antenna and the airframe of the aircraft as seen along the line 3-3 in FIG. 1 in accordance with the present invention.

### DESCRIPTION OF THE PREFERRED EMBODIMENTS

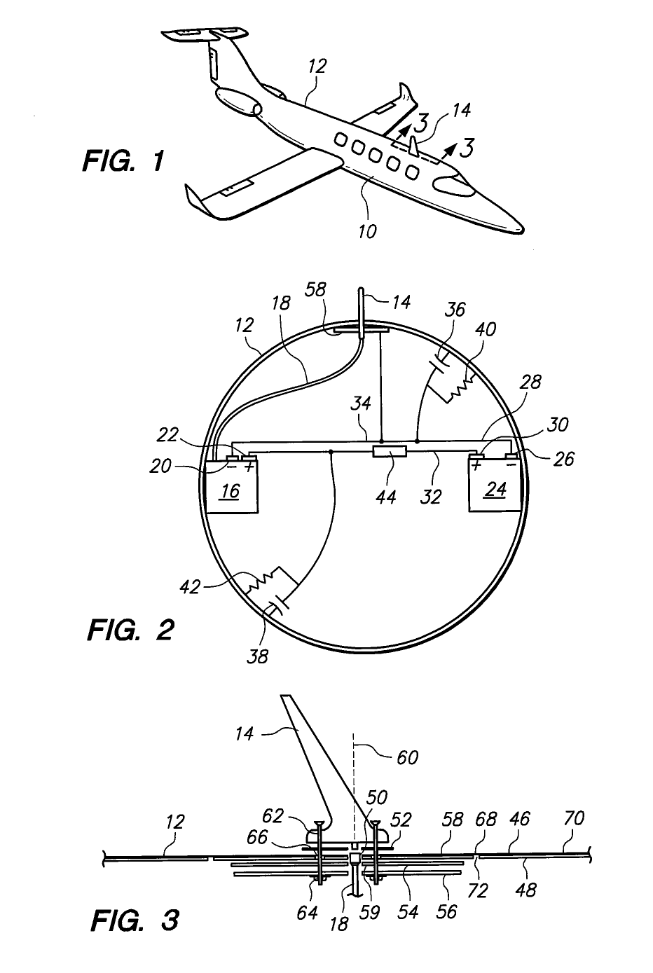

Referring initially to FIG. 1, an aircraft having an isolated ground to prevent aircraft structure fires due to electrical shorts is shown and generally designated 10. As shown in FIG. 1, the aircraft 10 is formed from a composite material airframe 12, preferably a graphite/epoxy composite airframe. Further, the aircraft 10 includes an antenna 14 for connection to an electronic device inside the airframe 12 for trafficking signals. In certain embodiments, the aircraft 10 may have several antennae 14.

Referring to FIG. 2, the electronic device 16 is mounted to the airframe 12 and electronically connected to the antenna 14 by a coaxial cable 18. As shown, the electronic device 16 includes a negative terminal 20 and a positive terminal 22 for electrical connection to a voltage source 24 mounted to the airframe 12. Specifically, the voltage source 24 includes a negative bus bar 26 that is electrically connected to the negative terminal 20 of the electronic device 16 by a ground wire 28. Also, the voltage source 24 includes a positive bus bar 30 that is electrically connected to the positive terminal of 22 of the electronic device 16 by a power wire 32. As shown, the electronic device 16, voltage source 24, and wires 28, 32 form a circuit 34 or electrical system that is electrically isolated from the airframe 12. Further, while the electronic device 16 and voltage source 24 are shown directly mounted to the airframe 12, the connection therebetween may be indirect.

As shown, the circuit 34 is equipped to eliminate radio interference and reduce noise by outside electromagnetic sources such as the onboard generators. Specifically, the ground wire 28 is connected to a groundside capacitor 36 that is coupled to the airframe 12. Also, the power wire 32 is connected to a powerside capacitor 38 that is coupled to the airframe 12. Additionally, a groundside and powerside resistor 40, 42, respectively, may be connected in parallel with the capacitor 36, 38 to bleed off static electricity between the circuit 34 and the airframe 12. As also shown in FIG. 2, the circuit 34 includes a circuit breaker 44 that is interconnected on the power wire 32.

Referring now to FIG. 3, the structural connection between the antenna 14 and airframe 12 may be understood. As shown, the airframe 12 has an external surface 46 and an internal surface 48 that define an aperture 50. For the present invention, the antenna 14 is mounted to the airframe 12 by external and internal insulating gaskets 52, 54. As shown, each insulating gasket 52, 54 surrounds the aperture 50. Further, an antenna backing plate 56 is positioned against the internal insulating gasket 54 to surround the aperture 50. Also, a ground plane 58 made from an expanded foil metal mesh is positioned against the airframe 12 about the aperture 50 in order to ground the antenna 14. For grounding purposes, the ground plane 58 extends around the vicinity of the antenna 14 to the extent needed for good antenna performance. For example, a typical ground plane mesh could be one foot in diameter, with the antenna at the center of the mesh. Structurally, the ground plane 58 is embedded in the airframe 12 and is insulated from the composite skin at the external surface 46 by a fiberglass-type insulating layer (not shown). Also, it can be seen that the ground plane 58 is electrically connected to the ground wire 28 (shown in FIG. 2) through coaxial cable 18 by a connection 59. As shown in FIG. 3, the antenna 14 defines an axis 60 that is substantially perpendicular to the ground plane 58. With this structure, the internal insulating gasket 54 is positioned between the backing plate 56 and the ground plane 58 adjacent the airframe 12.

In FIG. 3, it can be seen that screws 62 and nut plates 64 are provided to tighten the antenna 14 to the backing plate 56 about the airframe 12. In order to isolate the airframe 12 from the screws 62, annular insulators 66 are provided about the screws 62. Also, in FIG. 3, the coaxial cable 18 is shown for connection to the antenna 14 to allow electronic communication between the antenna 14 and the electronic device 16.

As shown in FIG. 3, the ground plane 58 is embedded in the airframe 12 and extends around the antenna 14 to a perimeter 68. For protection from lightning strikes, the aircraft 10 further includes a lightning protective mesh 70 embedded in the airframe 12 to extend substantially the length of the aircraft 10. As shown, the lightning protective mesh 70 is not positioned near the antenna 14. Instead, electrical contact between the ground plane 58 and the protective mesh 70 is prevented by the presence of the gap 72. As a result of the mesh 70, lightning is directed around the fuselage of the aircraft 10 rather than through the aircraft 10.

As noted above, due to the structure of the aircraft 10, a mechanic, or an active resistance monitoring device, may detect circuits that are shorted to the airframe 12. Specifically, a short is identified when the resistance between the wire 28 and the airframe 12 has a resistance value less than the resistor 42. Likewise, a short is identified when the resistance between the wire 32 and the airframe 12 has a resistance value less than the resistor 42. Thus, a short to the airframe 12 can occur without damage, then be identified and corrected.

While the particular Aircraft with Isolated Ground as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. An aircraft with isolated ground which comprises:
an airframe made of a composite material;
a voltage source mounted on the airframe;
at least one electronic device mounted on the airframe;
a power wire isolated from the airframe and connecting the electronic device to the voltage source;
a circuit breaker interconnected to the power wire; and
a ground wire isolated from the airframe and grounding the electronic device to the voltage source.

2. An aircraft as recited in claim 1 further comprising:
a powerside capacitor interconnecting the power wire and the airframe; and
a groundside capacitor interconnecting the ground wire and the airframe, wherein the capacitors reduce electromagnetic interference.

3. An aircraft as recited in claim 2 wherein the voltage source has a positive bus bar and a negative bus bar, wherein the powerside capacitor connects the positive bus bar of the voltage source to the airframe; and wherein the groundside capacitor connects the negative bus bar of the voltage source to the airframe.

4. An aircraft as recited in claim 1 further comprising:
an antenna defining an antenna axis;
a mounting means for affixing the antenna to the airframe with the antenna electrically isolated therefrom; and
a ground plane electrically connected to the antenna, with said ground plane being perpendicular to the antenna axis.

5. An aircraft as recited in claim 4 wherein the ground plane is formed from a wire mesh.

6. An aircraft as recited in claim 4 further comprising a conductor means for electrically connecting the antenna to the electrical device for trafficking signals with the antenna.

7. An aircraft as recited in claim 6 wherein the airframe has an external surface and an internal surface and the airframe is formed with an aperture extending between the external and internal surfaces, and further wherein the mounting means comprises:
a first insulating gasket positioned outside of the external surface to surround the aperture;
a second insulating gasket positioned inside of the internal surface to surround the aperture; and
a backing plate positioned against the second insulating gasket to surround the aperture and to position the second insulating gasket between the backing plate and the airframe for connection of the conducting means with the antenna through the aperture.

8. An aircraft as recited in claim 7 wherein the ground plane is mounted between the second gasket and the internal surface of the airframe.

9. An aircraft as recited in claim 1 wherein the composite material is a graphite/epoxy composite.

10. An isolated ground electrical system for use in an aircraft having an airframe made of a composite material which comprises:
a voltage source mounted on the airframe, the voltage source having a positive bus bar and a negative bus bar;
at least one electronic device mounted on the airframe, the electronic device having a positive terminal and a negative terminal;
a power wire isolated from the airframe and connecting the positive terminal of the electronic device to the positive bus bar of the voltage source;
a circuit breaker interconnected to the power wire; and
a ground wire isolated from the airframe and connecting the negative terminal of the electronic device to the negative bus bar of the voltage source.

11. A system as recited in claim 10 further comprising:
a powerside capacitor interconnecting the power wire and the airframe; and
a groundside capacitor interconnecting the ground wire and the airframe, wherein the capacitors reduce electromagnetic interference.

12. A system as recited in claim 10 further comprising:
an antenna defining an antenna axis;
a mounting means for affixing the antenna to the airframe with the antenna electrically isolated therefrom; and
a ground plane electrically connected to the antenna, with said ground plane being perpendicular to the antenna axis.

13. A system as recited in claim 12 further comprising a conductor means for electrically connecting the antenna to the electrical device for trafficking signals with the antenna.

14. A system as recited in claim 13 wherein the airframe has an external surface and an internal surface and the airframe is formed with an aperture extending between the external and internal surfaces, and further wherein the mounting means comprises:
a first insulating gasket positioned outside of the external surface to surround the aperture;
a second insulating gasket positioned inside of the internal surface to surround the aperture; and
a backing plate positioned against the second insulating gasket to surround the aperture and to position the second insulating gasket between the backing plate and the airframe for connection of the conducting means with the antenna through the aperture.

15. A system as recited in claim 14 wherein the ground plane is embedded in the airframe.

16. A method of grounding electronic devices in an aircraft having an airframe made of a composite material which comprises the steps of:
mounting a voltage source on the airframe;
positioning at least one electronic device in the airframe;
electrically connecting the electronic device to the voltage source with a power wire isolated from the airframe;
interconnecting a circuit breaker to the power wire; and
electrically connecting the electronic device to the voltage source with a ground wire isolated from the airframe.

17. A method as recited in claim 16 further comprising the steps of:
interconnecting the power wire and the airframe with a powerside capacitor; and
interconnecting the ground wire and the airframe with a groundside capacitor to reduce electromagnetic interference.

18. A method as recited in claim 17 further comprising the steps of:
affixing an antenna to the airframe, with the antenna electrically isolated from the airframe, and with the antenna defining an antenna axis;
grounding the antenna to a ground plane perpendicular to the antenna axis; and
electrically connecting the antenna to the electrical device for trafficking signals with the antenna.

19. A method as recited in claim 18 wherein the airframe has an external surface and an internal surface, wherein the airframe is formed with an aperture extending between the external and internal surfaces, and wherein the affixing step comprises:
positioning a first insulating gasket outside of the external surface to surround the aperture;
positioning a second insulating gasket inside of the internal surface to surround the aperture; and
positioning a backing plate against the second insulating gasket to surround the aperture and to position the second insulating plate between the backing plate and the airframe for electrical connection of the antenna through the aperture.

20. A system as recited in claim 19 wherein the affixing step further includes the step of mounting the ground plane between the second gasket and the internal surface of the airframe.
